(19) United States
(12) Patent Application Publication
(10) Pub. No.: US 2013/0075121 A1
(43) Pub. Date: Mar. 28, 2013

(54) IMPACT TOOL

(71) Applicants: Mizuho Nakamura, Ibaraki (JP); Katsuhiro Oomori, Ibaraki (JP)

(72) Inventors: Mizuho Nakamura, Ibaraki (JP); Katsuhiro Oomori, Ibaraki (JP)

(73) Assignee: HITACHI KOKI CO., LTD., Tokyo (JP)

(21) Appl. No.: 13/574,747

(22) PCT Filed: Mar. 8, 2011
(86) PCT No.: PCT/JP2011/055868

§ 371 Date: Jul. 23, 2012

(30) Foreign Application Priority Data
Mar. 8, 2010 (JP) 2010-051191

(51) Int. Cl. B25B 21/02

(52) U.S. Cl. CPC B25B 21/02
USPC 173/94

(57) ABSTRACT

An impact tool including: a motor; a housing that accommodates the motor; a hammer rotated by the motor in a rotating direction; an anvil struck by the hammer in the rotating direction; an end tool holding portion connected to the anvil and protruding from a front part of the housing; and a load receiving portion that receives a load of the hammer in a rear direction.

### TECHNICAL FIELD

Aspects of the present invention relate to an impact tool that is driven by a motor and realizes a new striking mechanism portion.

### BACKGROUND ART

An impact tool, which is an example of an electric cool, drives a rotating striking mechanism portion by using a motor as a driving source to apply torque and a striking force to an anvil, so as to intermittently transmit a rotating impact force to an end tool and perform an operation such as screwing. In recent years, a brushless DC motor is widely used as the driving source. The brushless DC motor is, for instance, a DC (direct current) motor that does not include a brush (a rectifying brush), and uses a coil (winding wire) in a stator side and a magnet (a permanent magnet) in a rotor side and sequentially supplies an electric power driven in an inverter circuit to a predetermined coil to rotate the rotor. The inverter circuit is formed by using an output transistor of a large capacity such as an FET (Field Effect Transistor) or an IGBT (Insulating Gate Bipolar Transistor) and is driven by a large current. The brushless DC motor has better torque characteristics than that of a DC motor with a brush, and can fasten a screw, a bolt, etc. to a processed member by a stronger force.

JP-A-2009-72888 discloses an example of the impact tool using the brushless DC motor. In JP-A-2009-72888, the impact tool has a continuously rotating type striking mechanism portion. When a torque is applied to a spindle through a power transmitting mechanism portion (a speed-reduction mechanism portion), a hammer, which is engaged with the spindle so as to be movable in a direction of a rotary shaft of the spindle, is rotated, so as to rotate an anvil abutting to the hammer. The hammer and the anvil respectively have two hammer protruding portions (striking portions) which are respectively arranged symmetrically with each other at two positions on a rotation plane. These protruding portions are located at positions where the protruding portions are engaged with each other in a rotating direction. A rotating striking force is transmitted in accordance with the engagement of the protruding portions. The hammer is provided so as to freely slide in the axial direction relative to the spindle within a ring area that surrounds the spindle. An inverted V-shaped (substantially triangular shape) cam groove is provided to an inner peripheral surface of the hammer. A V-shaped cam groove is provided in the axial direction to an outer peripheral surface of the spindle. The hammer is rotated via balls (steel balls) inserted between the cam groove provided to the spindle and the cam groove provided to the hammer.

### SUMMARY OF INVENTION

### Technical Problem

In the related-art power transmitting mechanism portion, a spindle and a hammer are held via the balls arranged in the cam grooves. The hammer can be retreated rearward in the axial direction relative to the spindle by a spring arranged at a rear end thereof. Thus, the number of components in the part of the spindle and the hammer becomes large. Accordingly, high attaching accuracy between the spindle and the hammer is required, thereby increasing the manufacturing cost.

Further, in a technique disclosed in JP-A-2009-72888, during an impact by the hammer, since the retreated hammer is pushed back forward by the spring and rotated to apply an impact to the spindle, a thrust component of force is generated forward in the axial direction relative to the spindle during the impact, so that a so-called coming out phenomenon in which an end tool is separated from a screw head hardly occurs. However, in a striking mechanism of a new structure according to an exemplary embodiment of the present invention, which will be described later, since a hammer is rotated only in a rotating direction and is not moved in the direction of a rotating axis, only a force in the rotating direction (a radial direction) is generated and a force in the direction of the rotating axis (a thrust direction) is not generated.

Accordingly, it is an object of the present invention to provide an impact tool formed by using a new striking mechanism.

Another object of the present invention is to provide an impact tool that realizes a striking mechanism by a hammer and an anvil having a simple mechanism, wherein a load generated when an impact tool is pressed to a member to be fastened can be effectively received through a housing.

Another object of the present invention to provide an impact tool in which a load generated when a tool main body is pressed to a member to be fastened is not applied to a rotating portion or a bearing portion of a planetary gear mechanism.

### Solution to Problem

Representative features of the present invention are hereinafter described.

According to a first aspect of the present invention, there is provided an impact tool including: a motor; a housing that accommodates the motor; a hammer rotated by the motor in a rotating direction; an anvil struck by the hammer in the rotating direction; an end tool holding portion connected to the anvil and protruding from a front part of the housing; and a load receiving portion that receives a load of the hammer in a rear direction.

Further, according to a second aspect of the present invention, in the impact tool, the hammer may be connected to the motor through a first speed reducing mechanism portion connected to the motor and a second speed reducing mechanism portion connected to an output part of the first speed reducing mechanism portion, and the load receiving portion may receive a load of the second speed reducing mechanism portion in the rear direction.

According to a third aspect of the present invention, in the impact tool, the first speed reducing mechanism portion and the second speed reducing mechanism portion may each include a sun gear, a plurality of planetary gears and a ring gear, wherein the hammer may be connected to a planetary carrier of the second speed reducing mechanism portion, and wherein the sun gear of the second speed reducing mechanism portion may be connected to a planetary carrier of the first speed reducing mechanism portion.

According to a fourth aspect of the present invention, in the impact tool, the planetary carrier of the second speed reducing mechanism portion may include a hammer portion and an annular portion, and the annular portion may rotate relatively to the ring gear of the second speed reducing mechanism portion.

According to a fifth aspect of the present invention, in the impact tool, the load receiving portion may include the annular portion and the ring gear of the second speed reducing mechanism portion, and the load transmitted to the ring gear may be transmitted to the housing.

According to a sixth aspect of the present invention, in the impact tool, the load receiving portion may include a thrust bearing.

According to a seventh aspect of the present invention, there is provided an impact tool including: a motor; a housing that accommodates the motor; an inner cover and a hammer case accommodated in the housing; a hammer portion accommodated in a space defined by the inner cover and the hammer case and rotated by the motor in a rotating direction; an anvil accommodated in the space defined by the inner cover and the hammer case and struck by the hammer in the rotating direction; and an end tool holding portion protruding from a front part of the hammer case and connected to the anvil, wherein a rear part of the hammer portion, in an axial direction of the hammer portion, is supported so as to freely rotate relative to the inner cover.

According to an eighth aspect of the present invention, in the impact tool, a load receiving unit may be provided in a rear side of the hammer portion so as to receive an axial load and freely rotate relative to the inner cover.

According to a ninth aspect of the present invention, in the impact tool, the load receiving unit may be a thrust bearing unit provided in the rear side of the hammer portion

According to a tenth aspect of the present invention, there is provided an impact tool including: a motor; a housing that accommodates the motor; a hammer rotated by the motor in a rotating direction; and an anvil struck by the hammer in the rotating direction, wherein a thrust bearing is provided between a rear part of the hammer and the housing.

According to an eleventh aspect of the present invention, in the impact tool, the hammer may be rotated by the motor intermittently.

According to a twelfth aspect of the present invention, in the impact tool, a planetary gear may be supported by the hammer, and the thrust bearing may be provided at an outside of the planetary gear in a diametrical direction of the planetary gear.

According to a thirteenth aspect of the present invention, there is provided an impact tool including: a motor, a hammer rotated by the motor in a rotating direction, and an anvil struck by the hammer in the rotating direction, wherein the anvil is supported by the hammer so as to rotate freely.

According to a fourteenth aspect of the present invention, in the impact tool, the anvil may be directly fitted to the hammer.

### Advantageous Effects of Invention

According to the first aspect of the present invention, since the load receiving portion, that receives the load of the hammer in the rear direction, is provided in the impact tool, a thrust load is not transmitted to the speed reducing mechanism portion located in the rear part of the hammer. Thus, a friction loss between the hammer and the speed reducing mechanism portion is reduced. Further, since the thrust load in the rear side of the hammer can be received and an impact operation can be carried out, the impact operation can be performed stably and an operating life can be lengthened.

According to the second aspect of the present invention, since the hammer is connected to the motor through the first speed reducing mechanism portion and the second speed reducing mechanism portion and the load receiving portion receives the load of the second speed reducing mechanism portion in the rear direction, the impact operation can be performed more stably.

According to the third aspect of the present invention, since the first speed reducing mechanism portion and the second speed reducing mechanism portion are formed by a double planetary gear type speed reducing unit including the sun gears, the plurality of planetary gears and the ring gears, a reduction gear ratio can be made large and the motor can be made compact.

According to the fourth aspect of the present invention, since the planetary carrier of the second speed reducing mechanism portion includes the hammer portion and the annular portion, and the annular portion can rotate relative to the ring gear of the second speed reducing mechanism portion, the load receiving portion that receives the thrust load of the hammer portion can be realized by using the ring gear of the second speed reducing mechanism portion.

According to the fifth aspect of the present invention, since the load receiving portion includes the annular portion and the ring gear of the second speed reducing mechanism portion, and the load transmitted to the ring gear is transmitted directly to the housing, the thrust load is not applied to the bearing units provided in the first and second speed reducing mechanism portions. Thus, a high thrust load can be received.

According to the sixth aspect of the present invention, since the load receiving portion is provided with the thrust bearing, a smooth movement can be ensured with high withstand thrust load.

According to the seventh aspect of the present invention, since the rear part of the hammer portion of the impact tool, in the axial direction of the hammer portion, is supported so as to freely rotate relative to the inner cover, the rotation of the hammer in the diametrical direction and in the axial direction is stabilized. Therefore, an impact efficiency from the hammer to the anvil is high.

According to the eighth aspect of the present invention, since in the rear part in the axial direction of the hammer portion, the load receiving unit is provided so as to receive the axial load and freely rotate relative to the inner cover, the impact operation can be performed stably and a long life operation can be achieved.

According to the ninth aspect of the present invention, since the load receiving unit is the thrust bearing unit provided in the rear side of the hammer portion, a smooth movement can be ensured and a high thrust load can be received.

According to the tenth aspect of the present invention, since the thrust bearing is provided between the rear part of the hammer and the housing, when a screw is fastened, a reaction force from the screw applied to the anvil can be received from the hammer to the housing. Further, since the reaction force is not transmitted from the hammer to the motor side, a member of the motor side in a power transmitting mechanism portion is hardly rubbed by the thrust bearing.

According to the eleventh aspect of the present invention, during the impact operation, since the hammer is not moved forward and backward, the thrust bearing can be arranged with a simple structure.

According to the twelfth aspect of the present invention, since the thrust bearing is provided outside in the diametrical direction of the planetary gear, the impact tool can be compactly formed in the axial direction.

According to the thirteenth aspect of the present invention, since the anvil to which an impact is applied is held so as to freely rotate by the hammer that applies the impact to the anvil, the anvil is hardly inclined to the hammer. Accordingly, the hammer can efficiently apply the impact to the anvil.

According to the fourteenth aspect of the present invention, since the anvil is directly fitted to the hammer, the anvil can be more accurately rotated relative to the hammer.

The above-described objects and other objects and novel features will become apparent from the description of the specification and drawings hereinafter.

### BRIEF DESCRIPTION OF DRAWINGS

FIG. 1 is a longitudinal sectional view showing an entire structure of an impact tool according to an exemplary embodiment of the present invention;

FIG. 2 is a side view of the impact tool according to the exemplary embodiment of the present invention;

FIG. 3 is an enlarged sectional view of a part in the vicinity of a striking mechanism shown in FIG. 1;

FIG. 4 is an exploded perspective view of a planetary gear speed reducing mechanism and the striking mechanism shown in FIG. 1;

FIG. 5 is a perspective view showing a form of an inner cover shown in FIG. 4;

FIG. 6 is a perspective view shown external appearances of a second ring gear and an elastic body shown in FIG. 4;

FIG. 7 is a diagram showing a perspective view of a half of a first planetary carrier assembly shown in FIG. 4 and a cross-section surface thereof;

FIG. 8 is a diagram showing a perspective view of a half of a second planetary carrier assembly shown in FIG. 4 and a cross-section surface thereof;

FIG. 9 is a perspective view showing the forms of the second planetary carrier assembly and an anvil shown in FIG. 4;

FIG. 10 is a perspective view showing the forms of the second planetary carrier assembly and the anvil shown in FIG. 4 from another angle;

FIG. 11 (11A, 11B, 11C, 11D, 11E, 11F) is a sectional view taken along a line A-A in FIG. 3, which shows an impact operation of hammers and striking pawls of the anvil and shows a movement of one turn in six phases;

FIG. 12 is a diagram for explaining a transmitting path of a thrust reaction force transmitted from the anvil to a housing;

FIG. 13 is a functional block diagram showing a driving control system of a motor of the impact tool according to the exemplary embodiment of the present invention;

FIG. 14 is a diagram showing a trigger signal during the operation of the impact tool, a driving signal of an inverter circuit, a rotating speed of the motor and a torque during the striking of the hammers and the anvil; and

FIG. 15 is a partial sectional view for explaining the structure of a part in the vicinity of an illuminant portion shown in FIG. 1.

### DESCRIPTION OF EMBODIMENTS

### First Exemplary Embodiment

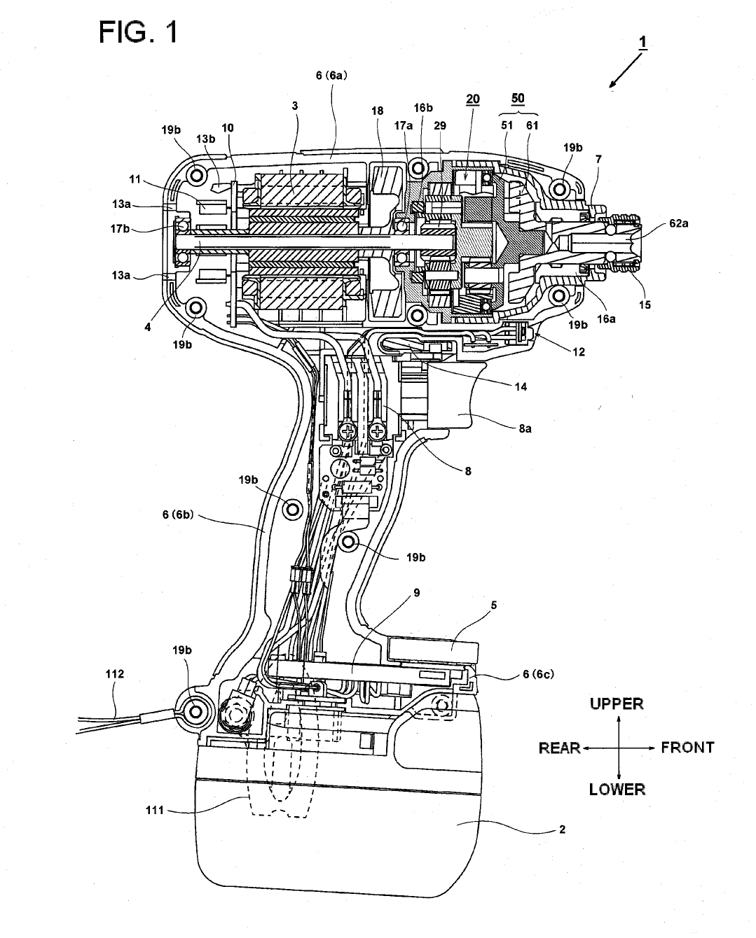

Hereinafter, an exemplary embodiment of the present invention will be described by referring to the drawings. In the following description, upper and lower directions, and front and rear directions correspond to directions shown in FIG. 1.

FIG. 1 is a longitudinal sectional view showing an entire structure of an impact tool 1 according to the present invention. The impact tool 1 uses a battery pack 2 that can be charged as a power source and a motor 3 as a driving source to drive an striking mechanism 50 and applies torque and a striking to an anvil 61 as an output shaft to transmit a continuous torque or an intermittent striking force to an end tool such as a driver bit not shown in the drawing and fasten a screw or a bolt.

The motor 3 is a brushless DC motor and accommodated in a substantially tubular trunk portion 6a of a housing 6 substantially formed in a T shape seen from a side surface. The housing 6 is formed so as to be divided to two right and left members substantially symmetrical with each other and these members are fixed by a plurality of screws not shown in the drawing. Therefore, in one of the divided housing 6 (in this exemplary embodiment, a left side housing), a plurality of screw bosses 19b are formed. In the other housing (a right side housing) not shown in the drawing, a plurality of tapped holes are formed. A rotating shaft 4 of the motor 3 is held so as to freely rotate by a bearing 17b in a rear end side of the trunk portion 6a and a bearing 17a provided in a part in the vicinity of a central part. In a rear part of the motor 3, an inverter base board 10 is provided on which six switching elements 11 are mounted. An inverter is controlled by the switching elements 11 to rotate the motor 3. At a position of a front side of the inverter base board 10 and opposed to a permanent magnet of a rotor, a rotating position detecting element (not shown in the drawing) such as a Hall IC is mounted to detect a position of the rotor.

In an upper part in a grip portion 6b integrally extending downward substantially at right angles to the trunk portion 6a of the housing 6, a trigger switch 8 and a normal/reverse switching lever 14 are provided. In the trigger switch 8, a trigger operating portion 8a is provided that is urged by a spring not shown in the drawing to protrude from the grip portion 6b. In a lower part in the grip portion 6b and in a battery holding portion 6c, a control circuit board 9 is accommodated on which a control circuit is mounted that has a function for controlling a speed of the motor 3 in accordance with an operation of the trigger operating portion 8a. On an upper surface of a front side of the control circuit board 9, a rotating type dial switch 5 is provided for setting an operation mode of the impact tool 1. The dial switch 5 is attached so that a part of an entire part of the dial switch 5 is exposed outside the housing 6. By the dial switch 5, the operation mode can be switched to a “drill mode (having no clutch mechanism)”, a “drill mode (having clutch mechanism)” or an “impact mode”. In the “impact mode”, the strength of a striking torque may be set so as to be stepwise or continuously varied.

To the battery holding portion 6c formed in the lower part of the grip portion 6b, the battery pack 2 in which a plurality of battery cells such as nickel hydrogen or lithium ion are accommodated is detachably attached. To a rear side of the battery holding portion 6c, a strap 112 is attached. To either a right side surface or a left side surface of the battery holding portion 6c, a detachable belt hook 111 can be attached.

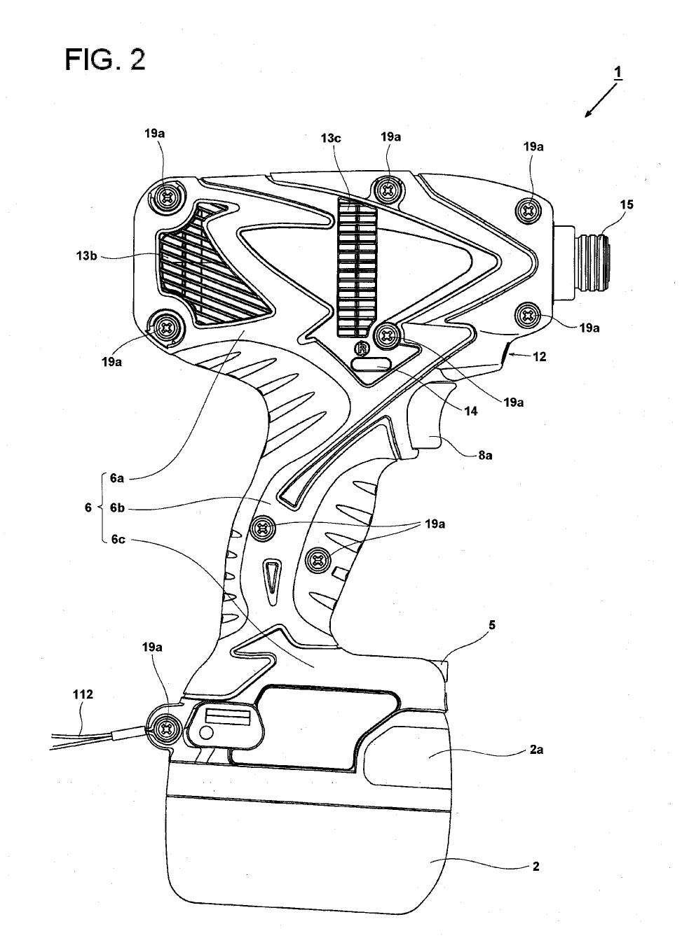

In a front part of the motor 3, a cooling fan 18 is provided that is attached to the rotating shaft 4 and rotates synchronously with the motor 3. The cooling fan 18 is a centrifugal fan that sucks air in the vicinity of the rotating shaft 4 irrespective of a rotating direction and exhausts air outside in the diametrical direction. By the cooling fan 18, the air is sucked from air intake ports 13a and 13b provided in a rear part of the trunk portion 6a. The air sucked into the housing 6 passes through a part between a rotor and a stator of the motor 3 and between magnetic poles of the stator, then, reaches the cooling fan 18 and is exhausted outside the housing 6 from a plurality of air exhaust ports 13c (see FIG. 2) formed in the vicinity of an outer peripheral side in the radial direction of the cooling fan 18.

The striking mechanism 50 is formed with two parts of the anvil 61 and a second planetary carrier assembly 51. The second planetary carrier assembly 51 has a hammer, which will be described later, connected to a rotating shaft of a planetary gear of a second stage of a planetary gear speed reducing mechanism 20 to apply a striking to the anvil 61. The striking mechanism 50 does not include a cam mechanism having a spindle, a spring, a cam groove and a ball, differently from a known striking mechanism which is presently widely used. The anvil 61 and the second planetary carrier assembly 51 are connected to each other by a fitting shaft and a fitting hole formed in the vicinity of a center of rotation so that only a relative rotation smaller than a half turn can be performed. The anvil 61 is formed integrally with an output shaft portion to which the end tool not shown in the drawing is attached. In a front end of the anvil, an attaching hole 62a is formed that has a hexagonal form in section in a vertical surface to an axial direction. A rear side of the anvil 61 is connected to a fitting shaft of the second planetary carrier assembly 51 and held so as to freely rotate relative to a hammer case 7 by a metal 16a in a part near a central part in the axial direction. In an end of the anvil 61, a sleeve 15 is provided to detachably attach the end tool by one touch. Detailed forms of the anvil 61 and the second planetary carrier assembly 51 will be described later.

The hammer case 7 is formed integrally with metal to accommodate the striking mechanism 50 and the planetary gear speed reducing mechanism 20 and attached to an inner part in the front side of the housing 6. The hammer case 7 serves to support the anvil 61 through a bearing mechanism and is fixed so that an entire part is covered with the right and left division type housing 6. In such a way, since the hammer case 7 is firmly held to the housing 6, a backlash is prevented from arising in a bearing part of the anvil 61 and a long life of the impact tool 1 can be achieved.

When the trigger operating portion 8a is pulled to start the motor 3, the speed of the rotation of the motor 3 is reduced by the planetary gear speed reducing mechanism 20 and the second planetary carrier assembly 51 is rotated at a rotating speed in the prescribed ratio to the rotating speed of the motor 3. When the second planetary carrier assembly 51 is rotated, its torque is transmitted to the anvil 61 through the hammer provided in the second planetary carrier assembly 51, so that the anvil 61 starts to rotate at the same speed as that of the second planetary carrier assembly 51. When a force applied to the anvil 61 is increased due to a reaction force received from the end tool side, a control unit, which will be described later, detects the increase of a fastening reaction force. Before the rotation of the motor 3 is stopped to be locked, the control unit changes a driving mode of the second planetary carrier assembly 51 so as to continuously or intermittently drive the hammer.

FIG. 2 is a side view of the impact tool 1 shown in FIG. 1. The housing 6 is formed with three portions (the trunk portion 6a, the grip portion 6b and the battery holding portion 6c). In the vicinity of the outer peripheral side in the radial direction of the cooling fan 18, the air exhaust ports 13c are formed for exhausting cooling air. The housing 6 is formed so as to be divided into right and left parts by a vertical surface passing the rotating shaft 4 of the motor 3 and the division type housing 6 is fixed by a plurality of screws 19a. In a front side of the housing 6, the sleeve 15 that forms an end tool holding portion protrudes. In a front side of a stepped portion of the sleeve 15, a compression type spring 15a is provided and the sleeve 15 is urged rearward in the axial direction by this spring. A front end of the spring 15a is held by a washer 15b whose axial movement is restricted by a retaining ring 15c. The sleeve 15 is preferably made of metal, for instance, iron or an arbitrary alloy. In the vicinity of a portion protruding inside the sleeve 15, a ball 24 is arranged in a hole formed in the anvil 61 and a part of the ball 24 is formed so as to protrude in the anvil 61. On an upper part of the battery holding portion 6c of the housing 6, the rotating type dial switch 5 is provided. Further, though not shown in the drawing, on a part of the housing 6, a control panel is provided on which a toggle switch for switching the driving mode (the drill mode, the impact mode) of the motor 3 or a switch for turning on and off a illuminant portion 12 are arranged. In the battery pack 2, a release button 2a is provided. By pressing the release buttons 2a located at both right and left sides while moving the battery pack 2 forward, the battery pack 2 can be detached from the battery holding portion 6c.

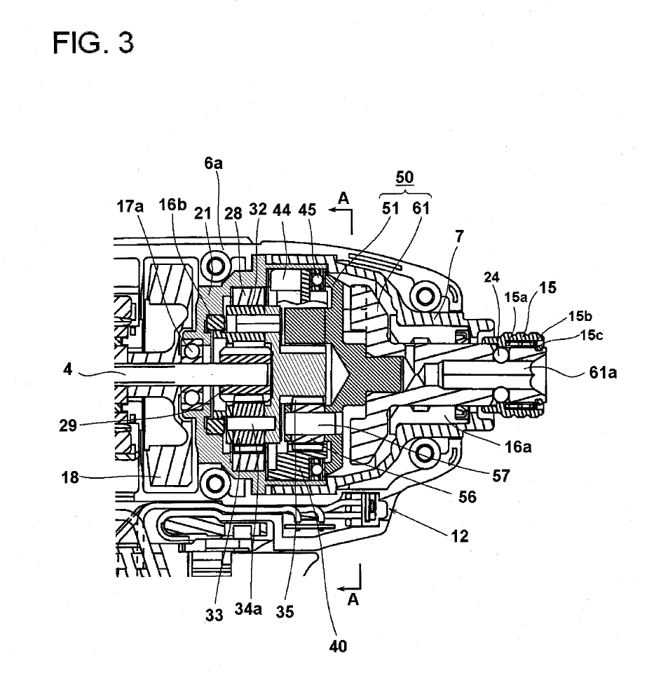

FIG. 3 is an enlarged sectional view of a part near the striking mechanism 50 shown in FIG. 1. The planetary gear speed reducing mechanism 20 in the exemplary embodiment is a planetary type, and includes two speed reducing mechanism portions of a first speed reducing mechanism portion and a second speed reducing mechanism portion. The speed reducing mechanism portions respectively include sun gears, a plurality of planetary gears and ring gears. To an end of the rotating shaft 4 of the motor 3, a first pinion 29 is attached and the first pinion 29 serves as a driving shaft (an input shaft) of the first speed reducing mechanism portion. In the periphery of the first pinion 29, a plurality of first planetary gears 33 are located and rotate in an inner peripheral side of a first ring gear 28. A needle pin 34a as a rotating shaft of the plurality of first planetary gears 33 is held by a first planetary carrier assembly 30 having a function of a planetary carrier. The first planetary carrier assembly 30 serves as an input shaft of the second speed reducing mechanism portion. In the vicinity of a central part of a front side, a second pinion 35 is formed.

In the periphery of the second pinion 35, a plurality of second planetary gears 56 are located and rotate in an inner peripheral side of a second ring gear 40. A needle pin 57 as a rotating shaft of the plurality of second planetary gears 56 is held by the second planetary carrier assembly 51. The second planetary carrier assembly 51 has the hammer as two striking pawls corresponding to striking pawls formed in the anvil 61. The second planetary carrier assembly 51 rotates in the same direction as that of the motor 3 in a prescribed reduction gear ratio as an output of the second speed reducing mechanism portion. To what degree the reduction gear ratio is to be set may be suitably set on the basis of factors such as a main object to be fastened (a screw or a bolt) or levels of an output of the motor 3 and a necessary fastening torque. In the present exemplary embodiment, the reduction gear ratio is set so that the rotating speed of the second planetary carrier assembly 51 is about ⅛ to 1/15 times as high as the rotating speed of the motor 3.

In an inner part of the trunk portion 6a and a front side of the cooling fan 18, an inner cover 21 is provided. The inner cover 21 is a member formed integrally with a synthetic resin such as plastic and attached along an inner wall of the housing. In a rear part of the inner cover 21, a cylindrical portion is formed. The cylindrical portion holds an outer ring of the bearing 17a that fixes the rotating shaft 4 of the motor 3 so as to freely rotate. Further, in a front side of the inner cover 21, three cylindrical portions having different diameters are provided in stepped forms. In a small inside diameter portion in a rear part, a cylindrical metal 16b is provided that serves as a bearing. In an intermediate inside diameter portion near a central part, the first ring gear 28 is inserted. In a large inside diameter portion in a front part, the second ring gear 40 and a thrust bearing 45 are accommodated. In the present exemplary embodiment, a rear side of the thrust bearing 45 provided in the rear part of the hammer is fixed by the second ring gear 40 so as to be indirectly held by the housing 6. However, the present invention is not limited thereto, and the rear side of the thrust bearing may be held by the inner cover 21 or may be directly fixed by the housing 6. A small stepped portion is formed for holding a washer, which will be described later, or the like as well as the small inside diameter portion, the intermediate inside diameter portion and the large inside diameter portion. However, an explanation thereof will be omitted herein. The first ring gear 28 is attached to the inner cover 21 so as not to freely rotate. The second ring gear 40 is attached to the inner cover 21 so as to slightly rotate in the diametrical direction, however, substantially so as not to freely rotate. Since the inner cover 21 is attached to the inner part of the trunk portion 6a of the housing 6 so as not to freely rotate, the first ring gear 28 and the second ring gear 40 are fixed to the housing 6 in a non-rotating state.

The large inside diameter portion of the inner cover 21 is inserted into an inner part from an opening in a rear part of the hammer case 7. In an inner part of a space defined by the inner cover 21 and the hammer case 7, the planetary gear speed reducing mechanism 20 including the first and second speed reducing mechanism portions and the striking mechanism 50 including hammers 52 and 53 and the anvil 61 are accommodated. Accordingly, lubricating grease applied to the first and second speed reducing mechanism portions or the striking mechanism can be effectively prevented from flowing outside and the speed reducing mechanism and the striking mechanism can be stably operated for a long period. In the present exemplary embodiment, in a connecting part (a front end side of the inner cover 21 or a rear end side of the hammer case 7) in the axial direction of the inner cover 21 and the hammer case 7, a seal member is not provided. However, an arbitrary seal member such as an O ring may be provided.

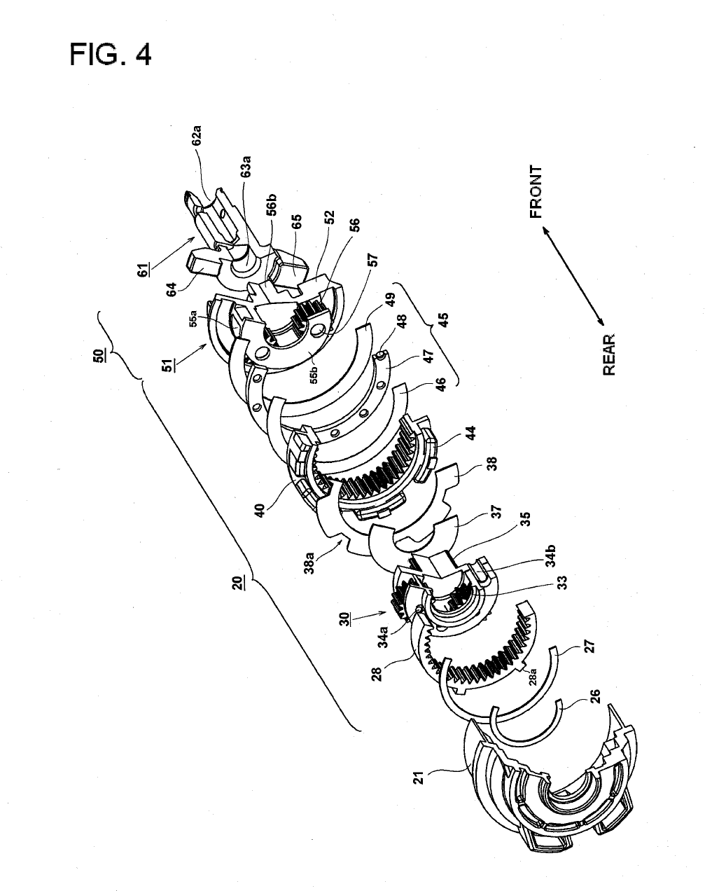

FIG. 4 is an exploded perspective view of the planetary gear speed reducing mechanism 20 and the striking mechanism 50, and parts are respectively partly shown in sections. The two speed reducing mechanism portions of the planetary gear speed reducing mechanism 20 are accommodated in the inner cover 21. In an inner part of the inner cover 21, washers 26 and 27 are inserted rearward from forward in the axial direction. The washer 26 is a patch made of metal for pressing a rear side end part of the needle pin 34a of the rotating first planetary carrier assembly 30. The washer 27 is a patch made of metal for positioning a rear side of the first ring gear 28. The first ring gear 28 serves as an outer gear of the first speed reducing mechanism portion, however, the first ring gear 28 is fixed in a rotating direction and is not rotated. Accordingly, at four positions of an outer peripheral side of the first ring gear 28, protruding ribs 28a are formed that protrude outside in the diametrical direction. The protruding ribs 28a are fitted to grooves, which will be described later, in the inner cover 21 so that the first ring gear 28 is fixed to the housing 6 so as not to rotate. Further, a rear end face of the first ring gear 28 in the axial direction abuts on an annular flat surface part formed in the inner wall of the inner cover 21 through the washer 27 so that a movement rearward in the axial direction is restricted.

The first planetary carrier assembly 30 has a function for holding revolution movements of the three first planetary gears 33 and taking out the revolution movements as outputs. In a front part of the first planetary gears 33, the second pinion 35 is formed that serves as an input of the second speed reducing mechanism portion and functions as the sun gear. In an outer peripheral side of the second pinion 35 of the first planetary carrier assembly 30, a washer 37 made of metal is located. The washer 37 serves to prevent the needle pin 57 of the second planetary carrier assembly 51 from slipping out and is inserted so that the first planetary carrier assembly 30 and the second planetary carrier assembly 51 can smoothly rotate.

Then, the second ring gear 40 forming the second speed reducing mechanism portion is arranged in the inner cover 21. The second ring gear 40 is fixed so as to abut on an annular flat surface part formed in the inner wall of the inner cover 21 through a washer 38 whose outside diameter is formed in a petal shape. The second ring gear 40 does not move in the axial direction (forward and backward) relative to the inner cover 21 and is rotated only by an elastically deformed part of an elastic body 44 and by a minute angle in a rotating direction. In an inner side and front side of the second ring gear 40, the second planetary carrier assembly 51 is attached. The second ring gear 40 is a non-rotating portion and the second planetary carrier assembly 51 is a rotating portion. Thus, between the second ring gear 40 and the second planetary carrier assembly 51, the thrust bearing 45 is provided. The thrust bearing 45 serves to receive a thrust load applied rearward in the axial direction from the second planetary carrier assembly 51, and, can receive the thrust load and smoothly rotate the second planetary carrier assembly 51 at the same time. The thrust bearing 45 includes bearing washers 46 and 49 arranged in front and rear parts and a perforated washer 47 having a plurality of holes 48 formed in the circumferential direction to attach bearing balls not shown in the drawing.

The second planetary carrier assembly 51 has a function for holding the revolution movement of the second planetary gear 56 around the second pinion 35 and converting the revolution movement into a rotating movement of the hammer 52. The second planetary gear 56 is held by disk portions 55a and 55b of the second planetary carrier assembly 51 by the needle pins 57. As a characteristic feature of the present exemplary embodiment, the second planetary carrier assembly 51 holds both ends of the needle pins 57 as the plurality of rotating shafts of the second planetary gear 56. Accordingly, a rear end side of the second planetary carrier assembly 51 has a cylindrical space and the second pinion 35 is accommodated in the space. In the vicinity of a central part of a front side of the second planetary carrier assembly 51, a fitting shaft 56b is formed that protrudes forward in the axial direction. The fitting shaft 56b is fitted to a cylindrical fitting hole 63a formed in the vicinity of a central part in a rear side of the anvil 61. By the fitting shaft 56b and the fitting hole 63a, the second planetary carrier assembly 51 and the anvil 61 are supported so as to relatively freely rotate. The anvil 61 has two striking pawls 64 and 65 extending outward in the radial direction from a rear end part and the attaching hole 62a formed in the front part for attaching the end tool.

In the impact tool according to the exemplary embodiment, when a striking is applied to the anvil 61 by the hammer, a striking force is hardly transmitted in a thrust direction (forward in the axial direction). Thus, for instance, when fastening a screw, in order to prevent the end tool from being run off from a screw head fitted thereto, it is important for an operator to strongly press an impact tool 1 main body forward. Therefore, to the anvil 61, a pressing reaction force is transmitted rearward in the axial direction. The reaction force is transmitted to the second planetary carrier assembly 51. The reaction force that is received by the second planetary carrier assembly 51 is transmitted to the second ring gear 40 through the thrust bearing 45. Since the rear end side of the second ring gear 40 is held by the inner cover 21, a thrust reaction force applied to the anvil 61 is transmitted to the thrust bearing 45, the second ring gear 40, the washer 38, the inner cover 21 and the housing 6 from the second planetary carrier assembly 51.

In a usual planetary gear speed reducing mechanism, a thrust reaction force applied to an anvil 61 is transmitted to a first planetary carrier assembly 40, a ball bearing (corresponding to 16b), the inner cover 21 and a housing 6 from a second planetary carrier assembly 51. Thus, there is a fear that the life of the ball bearing may be possibly shortened. However, in the structure of the present exemplary embodiment, since in a part between the second planetary carrier assembly 51 and the second ring gear 40 as a part where a rotation difference arises, the thrust bearing 45 high in its withstand thrust load is interposed, the thrust reaction force can be effectively evaded to the housing 6 substantially without giving an influence to the rotation and an striking operation and the rigidity of the impact tool 1 main body can be improved. Further, since the thrust reaction force applied to the anvil 61 is not applied to components of the first speed reducing mechanism portion, the metal 16b can be used in place of a ball bearing. Accordingly, the size of a bearing portion can be reduced, a dimension of a vertical direction and a dimension of the axial direction can be reduced and the weight can be lowered at the same time. Further, a reliability of the metal 16b is enhanced and the life of the impact tool 1 can be lengthened.

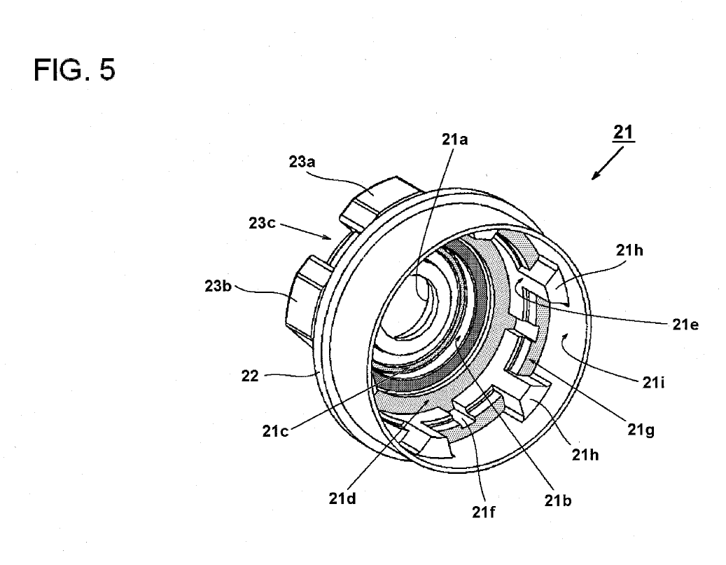

FIG. 5 is a perspective view showing the form of the inner cover 21 which is seen from a front side. The inner cover 21 has a substantially cup-shaped form having an opening part in the front side. In a center of a bottom part (a central part of a rear part), a through hole 21a is formed. In the front side from the through hole 21a, the small inside diameter portion 21b, the intermediate inside diameter portion 21e and the large inside diameter portion 21i are formed which have at least three diameters. Into the small inside diameter portion 21b, the ring shaped metal 16b (see FIG. 3) is inserted. A rear end part of the metal 16b is butted against a stepped portion 21c through a washer not shown in the drawing.

Into the intermediate inside diameter portion 21e, the first ring gear 28 (see FIG. 4) is inserted rearward from a front part in the axial direction through the washer 27 (see FIG. 4). As a result, the washer 27 is arranged so as to come into contact with a stepped portion 21d and the first ring gear 28 is restrained from moving rearward in the axial direction by the stepped portion 21d through the washer 27. Here, at plurality of parts (four parts in the present exemplary embodiment) on the circumference of the intermediate inside diameter portion 21e, cut out grooves 21f are formed which continuously extend in the axial direction and fitted to the protruding ribs 28a of the first ring gear 28. These members serve as a whirl-stop unit of the first ring gear 28. In such a way, since the first ring gear 28 cannot be moved rearward in the axial direction nor moved in the rotating direction by the inner cover 21, the first ring gear 28 can be stably held.

Into the large inside diameter portion 21i, the second ring gear 40 is inserted rearward from a front part in the axial direction through the washer 38 (see FIG. 4) having a plurality of recessed portions 38a formed on the circumference. Here, at a plurality of parts (six parts in the present exemplary embodiment) on the circumference of the large inside diameter portion 21i, protruding portions 21h are formed which continuously extend forward in the axial direction with the same inside diameter from the intermediate inside diameter portion 21e. The recessed portions 38a of the washer 38 are arranged on a stepped portion 21g so as to correspond to the protruding portions 21h. Further, the second ring gear 40 is located in front of the washer 38 in such a way that the protruding portions 21h enter gaps between the plurality of elastic bodies 44 attached to the second ring gear 40. Since a rear end face in the axial direction of the second ring gear 40, which will be described later, abuts on the stepped surface 21g through the washer 38, the second ring gear 40 cannot be moved rearward in the axial direction.

In an outer periphery near a central part in the axial direction of the inner cover 21, an annular flange portion 22 is formed whose radius is formed to be large. The flange portion 22 abuts on a stepped portion formed in the inner wall of the trunk portion 6a of the housing 6 to restrict an inner cover 21 to be moved rearward in the axial direction. In the rear side of the inner cover 21, protruding portions 23a and 23b are formed which protrude rearward in the axial direction. In the drawing, only one set of protruding portions 23a and 23b are seen, however, another one set of protruding portions 23a and 23b having the same forms are provided at positions mutually symmetrical with respect to a central axis. Between the protruding portions 23a and 23b, a space 23c is defined. This space 23c is engaged with a protruding portion not shown in the drawing which is formed in the inner wall side of the housing 6 so that the inner cover 21 is held so as not to rotate relative to the housing 6. Since the protruding portions 23a and 23b are whirl-stop units for preventing the inner cover 21 from rotating in the axial direction, the forms of the protruding portions are not limited to illustrated forms. When the inner cover 21 is formed with irregular parts so that the inner cover 21 may be held relative to the housing 6 so as not to rotate with respect to the central axis, the inner cover may have other form. Similarly, irregular parts such as the cut out grooves 21f or the protruding ribs 28a may be formed by reversing the irregular relation of them.

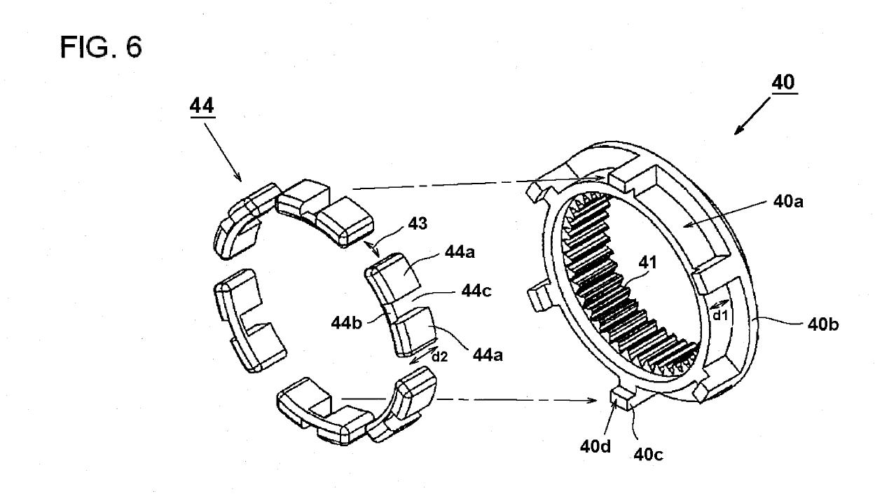

FIG. 6 is a perspective view showing external appearances of the second ring gear 40 and the elastic bodies 44. The second ring gear 40 has a gear portion 41 formed in an inner peripheral part which is engaged with the second planetary gear 56 (see FIG. 4) and cavity portions 40a formed as spaces for accommodating the elastic bodies 44 in an outer peripheral side. In a front side of the cavity portions 40a, a wall portion 40b is formed that continuously extends in the circumferential direction to restrict the movement of the elastic bodies in the axial direction. Between the plurality of cavity portions 40a, protruding portions 40c are formed that extend rearward in the axial direction. At rear end sides of the protruding portions 40c, abutting surfaces 40d are formed that abut on the stepped portion 21g of the inner cover 21 through the washer 38. These members serve as a whirl-stop unit as the second ring gear 40. The abutting surfaces 40d are formed at six positions on the circumference. Since the abutting surfaces respectively have very small areas, only the abutting surfaces 40d of the six parts abut on the washer 38 in the rear side of the second ring gear 40.

The six elastic bodies 44 which are used respectively include two elastic main bodies 44a and belts 44b for connecting together the elastic main bodies. The elastic bodies 44 are preferably formed by using a material such as rubber excellent in its damping effect. A part connected by the belt 44b forms a gap 44c. The gap 44c is located in the protruding portion 40c of the second ring gear 40. After the plurality of elastic bodies 44 are attached to the second ring gear 40, a gap is formed in a part shown by an arrow mark 43. In the gaps, the protruding portions 21h of the inner cover 21 are located so that the second ring gear 40 is attached to the inner cover 21. In that case, when a reaction force of a striking (a reaction force in a rotating direction) is transmitted to the second ring gear 40 from the hammer, the reaction force in the rotating direction is transmitted to the second ring gear 40. The reaction force is transmitted thereto by the protruding portions 21h of the inner cover 21 through the elastic bodies 44. Accordingly, the reaction force in the rotating direction generated in the second ring gear 40 can be effectively damped by the elastic bodies 44, so that the second ring gear is hardly swung by the impact tool 1 during a striking operation and a serviceable impact tool 1 can be realized.

To what degree an elastic force of the elastic body 44 is to be set may be arbitrarily set by considering whether an object to be fastened is a screw or a bolt. Further, to what degree the second ring gear 40 can rotate relative to the inner cover 21 owing to a deformation of the elastic body 44 may be suitably set. As for an angle, a minute angle smaller than several degrees is desirable. A relation between the thickness d1 of the cavity portion 40a in the axial direction and the thickness d2 of the elastic body 44 in the axial direction may be expressed by d2>d1. In that case, when the thrust load is not applied to the second ring gear 40 rearward in the axial direction, the abutting surfaces 40d float from the washer 38 and only the elastic bodies 44 abut on the washer 38. In such an arrangement relation, a movement of the second ring gear 40 rearward in the axial direction is damped.

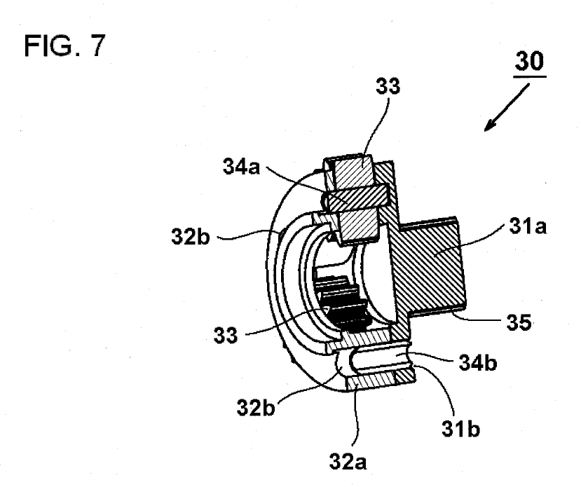

FIG. 7 is a diagram showing the structure of the first planetary carrier assembly 30 and showing a perspective view and a section of the half thereof. The first planetary carrier assembly 30 includes a planetary carrier including two pieces of a front side member 31a and a rear side member 32a and the plurality of first planetary gears 33. In a central part of a front part of the front side member 31a, the second pinion 35 is formed that serves as the input shaft of the second speed reducing mechanism portion. The front side member 31a and the rear side member 32a are fixed by through holes 31b and 32b provided at a plurality of portions in the circumferential direction and a roll pin 34b pressed in to the through holes 31b and 32b. In the present exemplary embodiment, since both the end parts of the needle pin 34a are held, the first planetary gear 33 is held in both sides thereof. Thus, the backlash of the first planetary gear 33 can be prevented from occurring and smoothly operated. As a result, the life of the impact tool can be extremely lengthened. In the present exemplary embodiment, the first planetary carrier assembly 30 is formed with the two pieces of the front side member 31a and the rear side member 32a, however, the first planetary carrier assembly 30 may be formed with an integrally formed one piece.

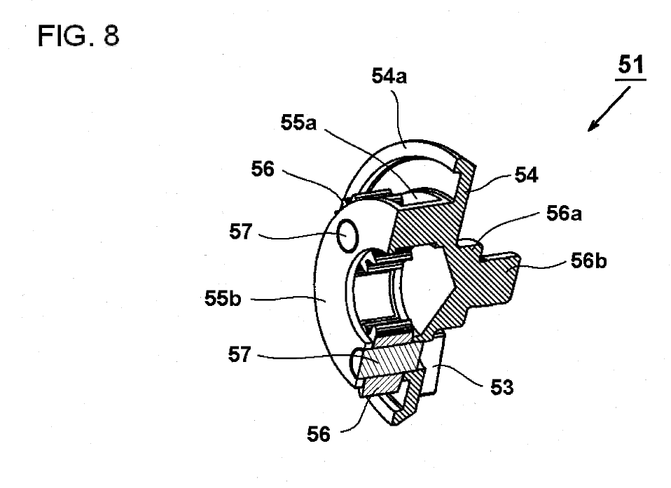

FIG. 8 is a diagram showing the structure of the second planetary carrier assembly 51 and showing a perspective view and a section of the half thereof. The second planetary carrier assembly 51 includes an integrally formed disk shaped member 54 as a base. A rear side of the disk shaped member 54 forms a planetary carrier for holding the second planetary gear 56. In a front side of the disk shaped member 54, the fitting shaft 56b fitted to the fitting hole 63a of the anvil 61 and the hammer 53 as an striking pawl protrude. In a rear side of the fitting shaft 56b, a butting portion 56a is formed whose diameter is larger than that of the fitting shaft 56b. The butting portion 56a can abut on the rear end part of the anvil 61. Thus, when the thrust load is applied to the anvil 61 rearward in the axial direction, the thrust load can be transmitted to the second planetary carrier assembly 51.

The second planetary gear 56 is held by the disk portions 55a and 55b by the needle pins 57. Here, in the present exemplary embodiment, since the second planetary gear 56 is held in both sides by the disk portions 55a and 55b by the needle pins 57, the occurrence of the backlash can be prevented and the second planetary gear can be smoothly operated. As a result, the life of the impact tool can be greatly lengthened. In the present exemplary embodiment, the second planetary carrier assembly 51 is formed with the integrally formed one piece, however, may be formed with two pieces as in the first planetary carrier assembly 30.

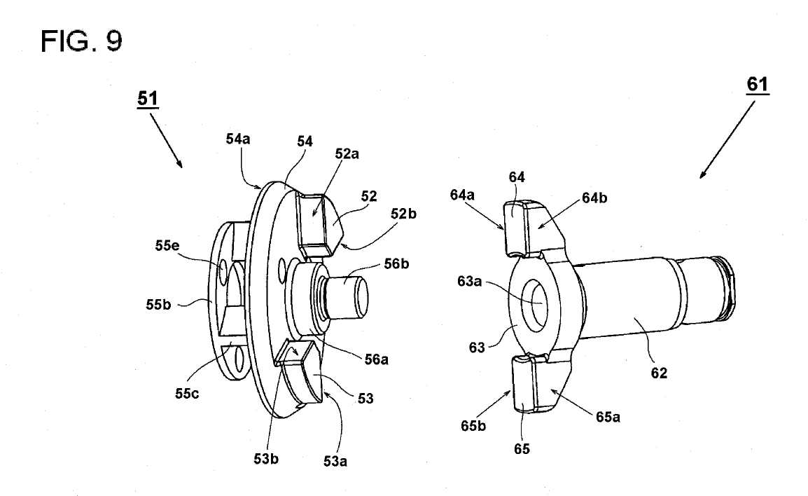

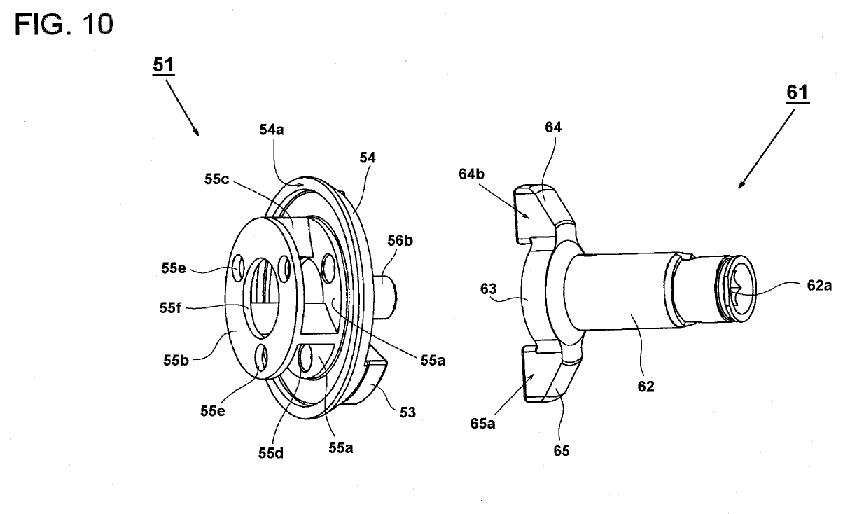

Next, referring to FIGS. 9 and 10, the detailed structures of the second planetary carrier assembly 51 and the anvil 61 forming the striking mechanism 50 will be described. FIG. 9 is a perspective view showing the forms of the second planetary carrier assembly 51 and the anvil 61 and showing a view of the second planetary carrier assembly 51 seen from an obliquely front part and a view of the anvil 61 seen from an obliquely rear part. FIG. 10 is a perspective view showing the forms of the second planetary carrier assembly 51 and the anvil 61 and showing a view of the second planetary carrier assembly 51 seen from an obliquely rear part and a partial view of the anvil 61 seen from an obliquely front part. The second planetary carrier assembly 51 includes the integrally formed disk shaped member 54 as a base. At two opposed parts of the disk shaped member 54, the two hammers 52 and 53 are formed that protrude forward in the axial direction. The hammers 52 and 53 function as striking portions (striking pawls). In the circumferential direction of the hammer 52, striking-side surfaces 52a and 52b are formed. In the circumferential direction of the hammer 53, striking-side surfaces 53a and 53b are formed. Both the striking-side surfaces 52a and 52b, and 53a and 53b are formed on flat surfaces so as to effectively come into face contact with struck-side surfaces of the anvil 61 which will be described later. The butting portion 56a and the fitting shaft 56b are formed forward from a part in the vicinity of a central axis of the disk shaped member 54. In a rear side in the vicinity of an outer periphery of the disk shaped member 54, an annular abutting surface 54a is formed which abuts on the thrust bearing 45.

In the rear side of the disk shaped member 54, the two disk portions 55a and 55b are formed so as to have a function of the planetary carrier. At three parts in the circumferential direction, connecting portions 55c are formed for connecting together the disk portions 55a and 55b. At three parts respectively in the circumferential directions of the disk portions 55a and 55b, through holes 55d and 55e are formed. Between the disk portions 55a and 55b, three second planetary gears 56 (see FIG. 8) are arranged and the needle pins 57 (see FIG. 8) as the rotating shafts of the second planetary gears 56 are attached to the through holes 55d and 55e. In a part near the central axis in the rear side of the disk portion 55b, a circular scooped hole 55f is formed. The second pinion 35 passes through the scooped hole 55f and is engaged with the second planetary gears 56. The second planetary carrier assembly 51 is preferably manufactured by an integral structure made of metal in view of strength and weight. Similarly, the anvil 61 is preferably manufactured by an integral structure made of metal in view of strength and weight.

In the anvil 61, a disk portion 63 is formed in a rear part of a cylindrical output shaft portion 62 and the two striking pawls 64 and 65 are formed that protrude in the circumferential direction of the disk portion 63. At both sides of the striking pawl 64 in the circumferential direction, struck-side surfaces 64a and 64b are formed. Similarly, at both sides of the striking pawl 65 in the circumferential direction, struck-side surfaces 65a and 65b are formed. When the second planetary carrier assembly 51 is normally rotated (in a rotating direction for fastening a screw or the like), the striking-side surface 52a abuts on the struck-side surface 64a and the striking-side surface 53a abuts on the struck-side surface 65a at the same time. Further, when the second planetary carrier assembly 51 is reversely rotated (a rotating direction for unfastening the screw), the striking-side surface 52b abuts on the struck-side surface 64b and the striking-side surface 53b abuts on the struck-side surface 65b at the same time. The forms of the hammers 52 and 53 and the striking pawls 64 and 65 are determined so that a timing of the abutment is set to the same time. Thus, since a striking operation is carried out at two positions symmetrical with each other with respect to an axis of rotation, the impact tool 1 can be formed so that a balance is good during an striking and the impact tool 1 may be hardly swung during the striking.

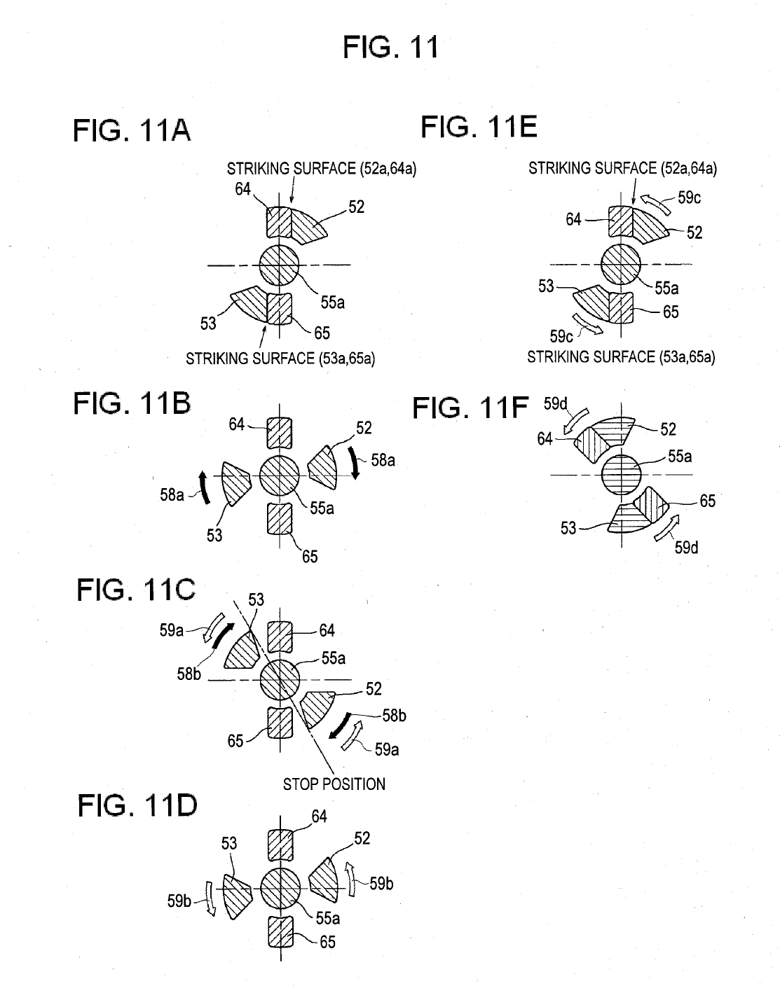

FIG. 11 (11A, 11B, 11C, 11D, 11E, 11F) is a sectional view showing in six phases a movement of one turn under a state that the hammers 52 and 53 and the striking pawls 64 and 65 are used. A section is a surface vertical to the axial direction and indicates a section taken along a line A-A in FIG. 3. In FIG. 11, the hammers 52 and 53 and the disk portion 55a are integrally rotating portions (a driving side). The striking pawls 64 and 65 are integrally rotating portions (a driven side). In a state shown in FIG. 11A, while a fastening torque applied from the end tool is low, the striking pawls 64 and 65 are pressed by the hammers 52 and 53 to rotate counterclockwise. However, when the fastening torque is high, and the striking pawls 64 and 65 cannot be rotated only by the pressing force of the hammers 52 and 53, the motor 3 is started to reversely rotate in order to reversely rotate the hammers 52 and 53. Under a state shown by FIG. 11A, a reverse rotation of the motor 3 is started. Thus, as shown in FIG. 11B, the hammers 52 and 53 are rotated in a direction shown by an arrow mark 58.

When the motor 3 is reversely rotated at a prescribed rotating seed, the driving of the motor 3 is stopped. The hammers 52 and 53 are more reversely rotated by inertia, and when the hammers 52 and 53 reach positions (stop positions of a reverse rotation) illustrated in FIG. 11C as shown by an arrow mark 58b, a driving current in a normally rotating direction is supplied to the motor 3 so that the hammers 52 and 53 start to rotate in a direction (a normally rotating direction) shown by an arrow mark 59a. When the hammers 52 and 53 are reversely rotated, it is important to assuredly stop the hammers 52 and 53 at prescribe positions so that the hammer 52 does not collide with the striking pawl 65 and the hammer 53 does not collide with the striking pawl 64. To what degree is arbitrary the stop positions of the hammers 52 and 53 are to be set before positions where the hammers 52 and 53 collide with the striking pawls 64 and 65. When a necessary fastening torque is large, a reverse angle may be set to a large angle. Further, the stop positions do not need to be set to the same positions every time. During an initial stage of a fastening operation, a reverse rotation angle may be set to a small angle, and when the fastening operation progresses, the reverse rotation angle may be set to a large angle. In such a way, when the stop positions are varied, since a time required for the reverse rotation can be set to a minimum value, a striking operation can be rapidly carried out for a short period of time.

Then, as shown in FIG. 11D, the hammers 52 and 53 are accelerated in a direction shown by an arrow mark 59b, and under a state that the hammers 52 and 53 are accelerated as shown by an arrow mark 59c, the striking-side surface 52a of the hammer 52 collides with the struck-side surface 64a of the striking pawl 64 at a position shown in FIG. 11E. At the same time, the striking-side surface 53a of the hammer 53 collides with the struck-side surface 65a of the striking pawl 65. As a result of this collision, a strong turning torque is transmitted to the striking pawls 64 and 65 so that the striking pawls 64 and 65 are rotated in a direction shown by an arrow mark 59d. A position shown in FIG. 11F shows a state that both the hammers 52 and 53 and the striking pawls 64 and 65 rotate by a prescribed angle from a state shown in FIG. 11A. Operations from the state shown in FIG. 11A to the state shown FIG. 11E are repeated again to fasten a member to be fastened until a proper torque is obtained.

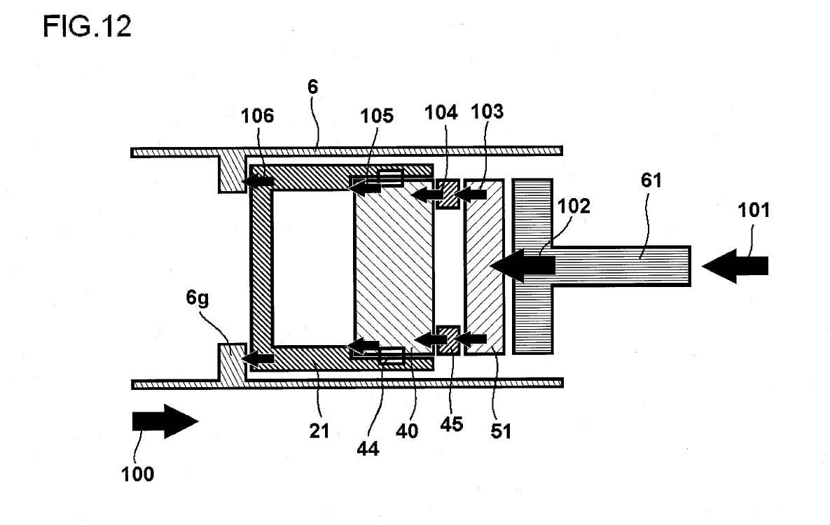

Next, referring to FIG. 12, a transmission path of a thrust reaction force transmitted to the housing 6 from the anvil 61 will be described. FIG. 12 schematically represents parts respectively. When an operator holds the grip 6b and presses the impact tool 1 forward to carry out an operation, a pressing force is applied toward a fastening member from the housing 6 in a direction shown by an arrow mark 100. As a reaction force of the pressing force, the anvil 61 receives a reaction force in a direction shown by an arrow mark 101 through the end tool. The reaction force shown by the arrow mark 101 is transmitted to the butting portion 56a of the hammer from the disk portion 63 of the anvil 61. The reaction force is transmitted to the second planetary carrier assembly 51 as shown by an arrow mark 102. In the rear side of the second planetary carrier assembly 51, since the thrust bearing 45 serving as a load receiving portion for receiving a load in the rearward direction is arranged, the reaction force is transmitted through the thrust bearing 45 as shown by arrow marks 103 and 104 and transmitted to the second ring gear 40. Since the rear side of the ring gear 40 is held by the stepped portion of the inner cover 21, the thrust reaction force is transmitted to the inner cover 21 as shown by an arrow mark 105.

Since the inner cover 21 is arranged inside the housing 6 and held by a protruding portion 6g protruding inside from the housing 6, the thrust reaction force is transmitted to the housing 6 as shown by an arrow mark 106. In such a way as described above, the load applied when the operator presses the impact tool to the fastening member is not received by a specific part and can be effectively received by an entire part of the housing 6. The load can be prevented from being concentrated on a specific part such as a bearing of the planetary gear speed reducing mechanism and the life of the impact tool can be lengthened.

Since the anvil 61 and the second planetary carrier assembly 51 rotate together, the second planetary carrier assembly 51 receives not only the thrust reaction force, but also a radial reaction force. The radial reaction force is transmitted to the second ring gear 40 from the second planetary carrier assembly 51, transmitted to the inner cover 21 from the second ring gear 40 through the elastic body 44 interposed in the spaces in the rotating direction between the second ring gear 40 and the inner cover 21 and finally transmitted to the housing 6. As described above, since the radial reaction force is transmitted to the housing 6 through the elastic body 44, the peak load of the radial reaction force can be effectively damped by the elastic body 44.

As described above, when the anvil 61 receives a force in the diametrical direction due to the reaction force from the end tool, if the second planetary carrier assembly 51 receives the force in the diametrical direction through the hammers 52 and 53, the first planetary carrier assembly 30 connected to the second planetary carrier assembly 51 receives the diametrical force by the metal 16b. Thus, the first planetary carrier assembly can assuredly receive the force from the second planetary carrier assembly 51, so that the second planetary carrier assembly 51 is not inclined. Accordingly, a transmission loss is reduced due to the inclination of the first planetary gears 33 relative to the first pinion 29.

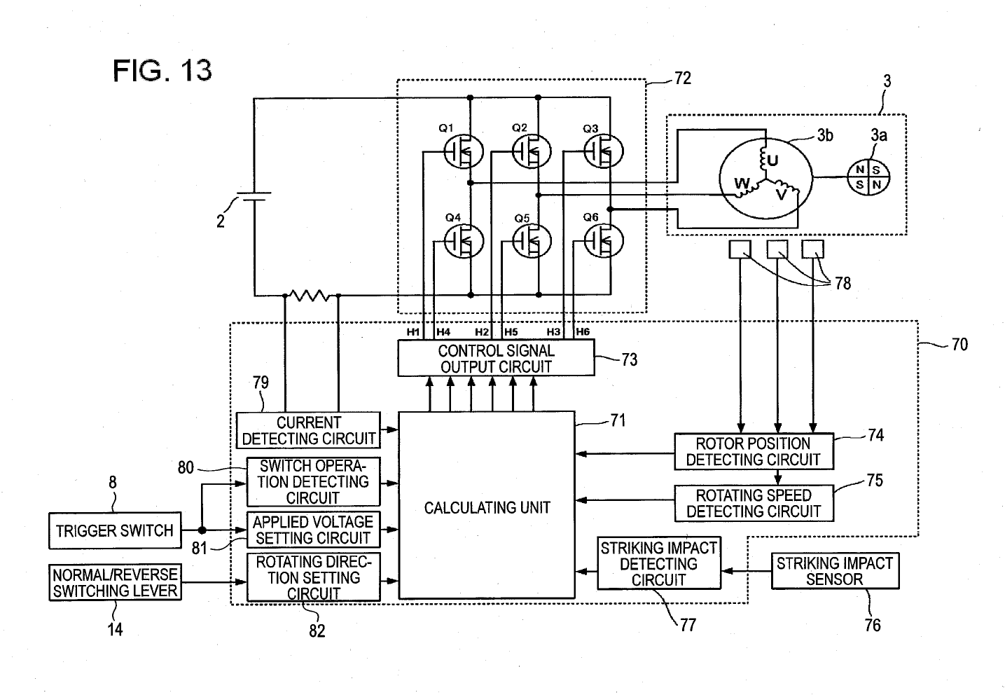

A structure and an operation of a driving control system of the motor 3 will be described hereinafter by referring to FIG. 13. FIG. 13 is a block diagram showing the structure of the driving control system of the motor 3. In the present exemplary embodiment, the motor 3 is formed by the brushless DC motor of three phases. The brushless DC motor is what is called an inner rotor type and includes a rotor 3a including a permanent magnet having a plurality of sets (two sets in the present exemplary embodiment) of N poles and S poles, a stator 3b including star-connected stator windings U, V and W of three phases and three rotating position detecting elements (Hall elements) 78 arranged at prescribed intervals, for instance, at intervals of angles of 60 degrees in the circumferential direction to detect the rotating position of the rotor 3a. In accordance with position detecting signals from the rotating position detecting elements 78, a current supply direction and time to the stator windings U, V and W are controlled and the motor 3 is rotated.

An electronic element mounted on the inverter base board 10 includes six switching elements Q1 to Q6 such as FETs connected in a three-phase bridge form. Gates of the six bridge-connected switching elements Q1 to Q6 are respectively connected to a control signal output circuit 73 mounted on the control circuit board 9 and drains or sources of the six switching elements Q1 to Q6 are respectively connected to the star-connected stator windings U, V and W. Thus, the six switching elements Q1 to Q6 carry out switching operations in accordance with switching element driving signals (driving signals of H4, H5 and H6) inputted form the control signal output circuit 73 to supply an electric power to the stator windings U, V and W by considering DC voltage of the battery pack 2 applied to an inverter circuit 72 as three-phase (a U phase, a V phase and a W phase) voltages Vu, Vv, Vw.

Three negative power source side switching elements Q4, Q5 and Q6 of the switching element driving signals (three-phase signals) for driving the gates of the six switching elements Q1 to Q6 respectively are supplied as pulse width modulation signals (PWM signals) H4, H5 and H6, and pulse widths (duty ratio) of the PWM signals are changed by a calculating unit 71 mounted on the control circuit board 9 in accordance with a detecting signal of an operation amount (a stroke) of the trigger operating portion 8a of the trigger switch 8 to adjust an amount of the supply of electric power to the motor 3 and control the start/stop and the rotating speed of the motor 3.

Here, the PWM signals are supplied either to positive power source side switching elements Q1 to Q3 of the inverter circuit 72 or to the negative power source side switching elements Q4 to Q6. The switching elements Q1 to Q3 or the switching elements Q4 to Q6 are switched at high speed to control the electric power supplied respectively to the stator windings U, V and W from the DC voltage of the battery pack 2. In the present exemplary embodiment, since the PWM signals are supplied to the negative power source side switching elements Q4 to Q6, the pulse widths of the PWM signals are controlled so that the electric power supplied respectively to the stator windings U, V and W may be adjusted and the rotating speed of the motor 3 may be controlled.

In the impact tool 1, the normal/reverse switching lever 14 is provided for switching the rotating direction of the motor 3. Every time that a rotating direction setting circuit 82 detects a change of the normal/reverse switching lever 14, the rotating direction setting circuit 82 switches the rotating direction of the motor and transmits a control signal to the calculating unit 71. The calculating unit 71 includes a central processing unit (CPU) that outputs a driving signal in accordance with a processing program and data, a ROM that stores the processing program or control data, a RAM that temporarily stores the data, a timer or the like, which are not shown in the drawing.

The control signal output circuit 73 generates the driving signals for alternately switching prescribed switching elements Q1 to Q6 in accordance with output signals of the rotating direction setting circuit 82 and a rotor position detecting circuit 74 and outputs the driving signals to the control signal output circuit 73. Thus, a current is alternately supplied to a prescribed winding of the stator windings U, V and W to rotate the rotor 3a in a set rotating direction. In this case, the driving signals applied to the negative power source side switching elements Q4 to Q6 are outputted as the PWM modulation signals in accordance with an output control signal of an applied voltage setting circuit 81. A current value supplied to the motor 3 is measured by a current detecting circuit 79 and the value is fed back to the calculating unit 71 so that the current is adjusted so as to have a set driving electric power. The PWM signals may be applied to the positive power source side switching elements Q1 to Q3.

To a control unit 70 mounted on the control circuit board 9, a striking impact sensor 76 is connected that detects a level of the striking arising in the anvil 61 and an output thereof is inputted to the calculating unit 71 through a striking impact detecting circuit 77. The striking impact sensor 76 can be realized by a sensor responsive to a vibration, a distortion, sound or the like. When a fastening operation is completed by a prescribed torque by using an output of the striking impact sensor 76, the motor 3 may be automatically stopped.

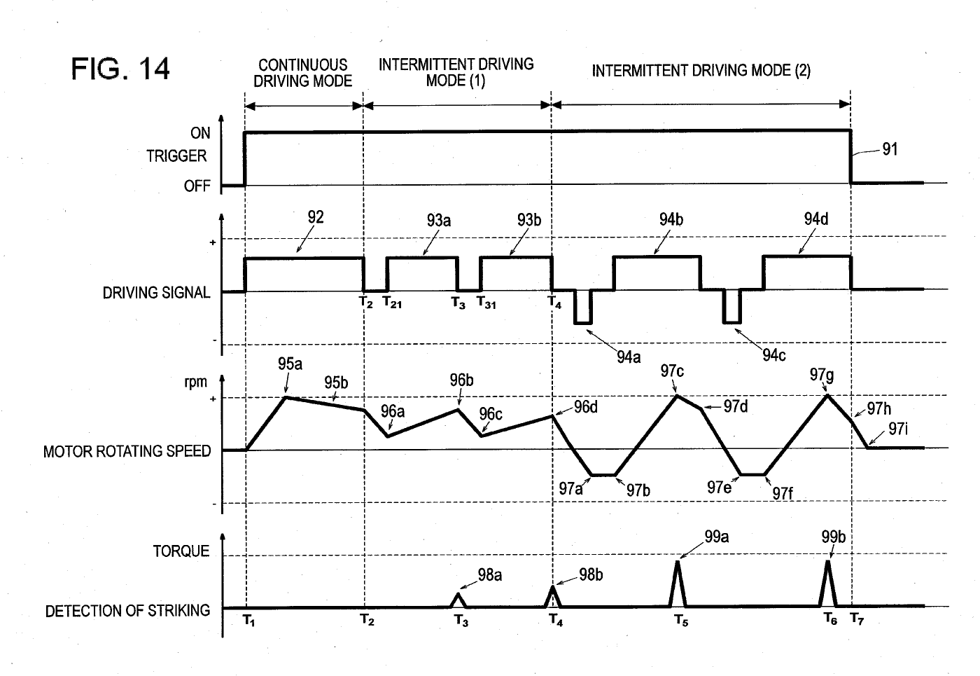

Next, a driving method of the impact tool 1 according to the exemplary embodiment will be described. In the impact tool 1 according to the present exemplary embodiment, the anvil 61 and the hammers 52 and 53 are formed so that the anvil and the hammers may relatively rotate at a rotation angle smaller than 180°. Accordingly, since the hammers 52 and 53 cannot rotate by half of one turn or more relative to the anvil 61, a rotation control thereof is peculiar. FIG. 14 is a diagram showing a trigger signal during an operation of the impact tool 1, a driving signal of the inverter circuit, the rotating speed of the motor 3 and a torque during the striking operation of the hammers 52 and 53 and the anvil 61. In each graph, an axis of abscissa shows a time and the axes of abscissas are respectively arranged to mutually correspond so that timings of the graphs may be respectively mutually compared.

In the impact tool 1 according to the present exemplary embodiment, in the case of a fastening operation in the impact mode, initially, the fastening operation is carried out at high speed in a “continuous driving mode”. When a necessary fastening torque value is large, the “continuous driving mode” is switched to an “intermittent driving mode (1)” to make the fastening operation. When the necessary torque value is larger, the “intermittent driving mode (1)” is switched to an “intermittent driving mode (2)” to carry out the fastening operation. In the continuous driving mode from time T₁ to T₂ in FIG. 14, the calculating unit 71 controls the motor 3 in accordance with a target rotating speed. Accordingly, the motor 3 is accelerated until the motor 3 reaches the target rotating speed shown by an arrow mark 95a. In the continuous driving mode, the anvil 61 is pressed by the hammers 52 and 53 to rotate. After that, when a fastening reaction force from the end tool attached to the anvil 61 is increased, since the reaction force transmitted to the hammers 52 and 53 from the anvil 61 is increased, the rotating speed of the motor 3 is gradually lowered as shown by an arrow mark 95b. Thus, the fall of the rotating speed is detected by a value of the current supplied to the motor 3. At the time T₂, the continuous driving mode is switched to a rotating and driving mode by the “intermittent driving mode (1)”.

The intermittent driving mode (1) is a mode in which the motor 3 is not continuously driven, but is intermittently driven, and the motor 3 is driven in a pulsating way so that a “stop to normally rotating drive” is repeated a plurality of times. Here, “driven in a pulsating way” means a driving control in which a gate signal applied to the inverter circuit 72 is allowed to pulsate so as to allow a driving current supplied to the motor 3 to pulsate, so that the rotating speed of the motor 3 or an output torque is allowed to pulsate. This pulsation is generated by repeating ON-OFF of the driving current for a large period (for instance, about several ten Hz to one hundred and several ten Hz) in such a way that the driving current supplied to the motor is turned off (stopped) from the time T₂ to T₂₁, the driving current of the motor is turned on (driven) from time T₂₁ to T₃, the driving current is turned off (stopped) from time T₃ to T₃₁ and the driving current is turned on from time T₃₁ to T₄. When the driving current is turned on, a PWM control is carried out to control the rotating speed of the motor 3. The period of pulsation is adequately smaller than a period for controlling the duty ratio (ordinarily several KHz).

In an example shown in FIG. 14, after the supply of the driving current to the motor 3 is stopped for a prescribed time from the time T₂ and the rotating speed of the motor 3 is lowered to a value shown by an arrow mark 96a, the calculating unit 71 (see FIG. 13) transmits a driving signal 93a to the control signal output circuit 73 to supply a pulsating driving current (a driving pulse) to the motor 3 and accelerate the motor 3. A control during the acceleration does not necessarily mean a driving in the duty ratio of 100%, but may indicate a control in the duty ratio lower than 100%. Then, at a spot shown by an arrow mark 96b, the hammers 52 and 53 strongly collide with the anvil 61, so that a striking torque is generated as shown by an arrow mark 98a. When a striking force is applied to the anvil 61, the supply of the driving current to the motor 3 is stopped again for a prescribed time. After the rotating speed of the motor 3 is lowered as shown by an arrow mark 96c, the calculating unit 71 transmits a driving signal 93b to the control signal output circuit 73 to accelerate the motor 3. Then, at a spot shown by an arrow mark 96d, the hammers 52 and 53 strongly collide with the anvil 61 to generate the striking torque as shown by an arrow mark 98b. In the intermittent driving mode (1), an intermittent driving in which the above-described “stop to normally rotating drive” of the motor 3 is repeated is repeated once or a plurality of times. When a higher fastening torque is necessary, this state is detected to switch the intermittent driving mode (1) to a rotating and driving mode by the intermittent driving mode (2). Whether or not the high fastening torque is necessary can be decided depending on whether or not the rotating speed of the motor 3 (a rotating speed in the vicinity of the arrow mark 96d) when a striking force shown by the arrow mark 98b is applied is a prescribed rotating speed (a threshold value) or lower.

The intermittent driving mode (2) is a mode in which the motor 3 is intermittently driven, and the motor 3 is driven in a pulsating way like the intermittent driving mode (1) so that a “stop to reversely rotating drive, to stop, and to normally rotating drive” is repeated a plurality of times. Namely, in the intermittent driving mode (2), since not only the normally rotating drive of the motor 3, but also a reversely rotating drive is added, after the hammers 52 and 53 are reversely rotated by a sufficient relative angle to the anvil 61, the hammers 52 and 53 are accelerated and allowed to vigorously collide with the anvil 61. The hammers 52 and 53 are driven in such a way to generate a strong fastening torque in the anvil 61.

In the examples shown in FIG. 14, when the intermittent driving mode (1) is switched to the intermittent driving mode (2) at the time T₄, the driving of the motor 3 is temporarily stopped. Then, a driving signal 94a of a negative direction is transmitted to the control signal output circuit 73 to reversely rotate the motor 3. A normal rotation and a reverse rotation are realized by switching signal patterns of the driving signals (on-off signals) respectively outputted to the switching elements Q1 to Q6 from the control signal output circuit 73. When the motor 3 is reversely rotated by a prescribed rotation angle (an arrow mark 97a), the driving of the motor 3 is temporarily stopped to start the normally rotating drive (an arrow mark 97b). Accordingly, a driving signal 94b of a positive direction is transmitted to the control signal output circuit 73. In a rotating and driving operation using the inverter circuit 72, the driving signal is not switched to a plus side or a minus side, however, in FIG. 14, in order to easily understand to which direction the rotating and driving operation is carried out, the driving signals are divided into and schematically expressed in a direction of + and a direction of −.

In the vicinity of a part where the rotating speed of the motor 3 reaches a maximum speed, the hammers 52 and 53 collide with the striking pawls 64 and 65 (an arrow mark 97c). In accordance with this collision, a fastening torque (99a) is generated that is extremely larger than the fastening torque (98a, 98b) generated in the intermittent driving mode (1). When the collision occurs in such a way, the rotating speed of the motor 3 is lowered as shown by arrow marks 97c to 97d. A driving signal to the motor 3 may be controlled to stop the moment the collision shown by the arrow mark 99a is detected. In that case, when an object to be fastened is a bolt or a nut, a reaction transmitted to the hand of an operator after a striking may be reduced. As in the present exemplary embodiment, even after the collision, since the driving current is supplied to the motor 3, a reaction force applied to the operator is smaller than that in the continuous driving mode. Thus, the intermittent driving mode is suitable for an operation under a state of an intermediate load. After that, the “stop to reversely rotating drive, to stop and to normally rotating drive” is similarly repeated a prescribed number of times to carry out the fastening operation by the strong fastening torque. At time T₇, the operator releases a trigger operation to stop the motor 3 and complete the fastening operation. The completion of the operation is carried out not only by releasing the trigger operation by the operator. When the calculating unit 71 decides that the fastening operation is completed by the set fastening torque on the basis of an output of the striking impact sensor 76 (see FIG. 13), the calculating unit may control the motor 3 to stop the driving.

In the present exemplary embodiment, in an initial stage of the fastening operation that the fastening torque may be low, the motor is rotated and driven in the continuous driving mode. As the fastening torque is increased, the fastening operation is carried out in the intermittent driving mode (1) by the intermittent driving of the motor including only a normal rotation. In the final stage of the fastening operation, the fastening operation is strongly carried out in the intermittent driving mode (2) by the intermittent drive including the normal rotation and the reverse rotation of the motor 3. The motor may be driven by using the intermittent driving mode (1) and the intermittent driving mode (2). Further, a control may be realized in which the intermittent driving mode (1) is not provided and the continuous driving mode is directly shifted to the intermittent driving mode (2). In the intermittent driving mode (2), since the normal rotation and the reverse rotation of the motor are alternately carried out, a fastening speed is greatly lower than that in the continuous driving mode or the intermittent driving mode (1). When the fastening speed is suddenly low, a discomfort received when an operation shifts to a striking operation is increased more than an impact tool having a known rotating striking mechanism. Thus, when the continuous driving mode (1) is shifted to the intermittent driving mode (2), the intermittent driving mode (1) is preferably interposed between them to obtain a natural operation. Further, when the fastening operation is carried out in the continuous driving mode or the intermittent driving mode (1) as much as possible, a time necessary for the fastening operation can be shortened.

As described above, according to the present exemplary embodiment, when the motor is continuously rotated, intermittently rotated only in a normally rotating direction and intermittently rotated in the normally rotating direction and a reversely rotating direction by using the hammer and the anvil having a relative rotation angle smaller than half of one turn, the fastening member can be efficiently fastened. Further, since the forms of the hammer and the anvil can have simple structures, the impact tool can be made to be compact and a cost can be lowered.

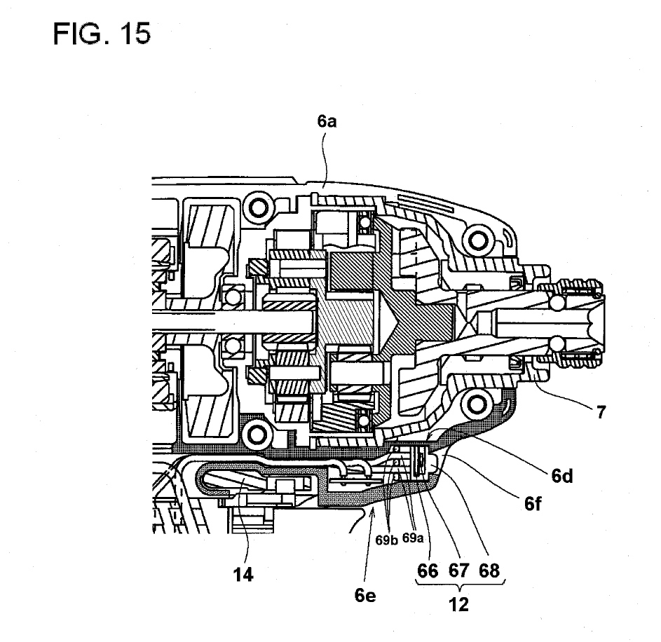

Next, referring to FIG. 15, a structure in the vicinity of the illuminant portion 12 will be described. FIG. 15 is a partly sectional view for explaining the structure in the vicinity of the illuminant portion 12. In the impact tool 1 of the exemplary embodiment, between the hammer case 7 and the illuminant portion 12, a partition portion 6d shown by a hatching is provided. The partition portion 6d is integrally formed as a part of the trunk portion 6a of the housing 6. In a lower part of the partition portion 6d, the illuminant portion 12 is provided. The illuminant portion 12 includes a base board 66, an LED chip 67 fixed to the base board 66 and a transparent resin body 68 for holding the base board 66. The transparent resin body 68 is transversely engaged with an irregular part (not shown in the drawing) of the trunk portion 6a of the housing 6 to be fixed to the housing 6. The transparent resin body 68 includes a lens. The lens is arranged in a front part of the LED chip 67. To the base board 66, two cords 69a for supplying an electric power are connected so as to extend rearward. In a lower part of the partition portion 6d and on a side surface of the housing 6, a plurality of ribs 69b for holding the cords 69a are formed.

In a lower part of the illuminant portion 12, a light accommodating chamber wall 6e shown by another hatching is provided. The light accommodating chamber wall 6e is formed integrally as a part of the trunk portion 6a of the housing 6 and is preferably manufactured by integrally forming with, for instance, a synthetic resin. At a front end part of the light accommodating chamber wall 6e and in front of the lens of the transparent resin body 68, a window 6f is provided and lights radiated from the LED chip 67 are emitted forward.

In the present exemplary embodiment, since the above-described structure is provided in the vicinity of the illuminant portion 12 of the impact tool 1, even if grease (lubricating oil) not shown in the drawing that is suitably applied to an inner part of the hammer case 7 leaks outside the hammer case 7, the grease is hardly spread to the illuminant portion 12, so that the illuminant portion 12 can be prevented from being stained with the grease. Further, the vibration of the hammer case 7 caused from the striking operation is transmitted to the illuminant portion 12 through the partition portion 6d. However, in the present exemplary embodiment, since the illuminant portion 12 is arranged in a closed space surrounded by the partition portion 6d and the light accommodating chamber wall 6e, the LED chip 67, the base board 66 and the cords 69a can be effectively prevented from being broken due to the vibration. When the structure that the illuminant portion 12 is accommodated in the closed space surrounded by the partition portion 6d and the light accommodating chamber wall 6e as described above is realized not for the hammer case of the impact tool 1, but as a structure having a partition portion provided between a gear case (for accommodating a pressure reducing mechanism portion) used for a driver drill and an LED light, the same effects can be achieved.

The present invention is described in accordance with the exemplary embodiment, however, the present invention is not limited to the above-described exemplary embodiment and various kinds of changes may be made within a scope without departing from the gist thereof. For instance, in the present exemplary embodiment, the brushless DC motor is used as the motor. The present invention is not limited thereto, and other kinds of motors may be used which can be driven in a normally rotating direction and a reversely rotating direction. Further, the forms of an anvil and a hammer are arbitrary. When the anvil and the hammer cannot relatively and continuously rotate (cannot rotate during a surmounting operation), and the anvil and the hammer relatively ensure a prescribed rotation angle smaller than 360 degrees or 180 degrees and have striking-side surfaces and struck-side surfaces, other forms may be employed.

This application claims priority from Japanese Patent Application No. 2010-051191 filed on Mar. 8, 2010, the entire contents of which are incorporated herein by reference.

### INDUSTRIAL APPLICABILITY

According to an aspect of the present invention, there is provided an impact tool formed by using a new striking mechanism.

According to another aspect of the present invention, there is provided an impact tool that realizes a striking mechanism by a hammer and an anvil having a simple mechanism, wherein a load generated when an impact tool is pressed to a member to be fastened can be effectively received through a housing.

According to another aspect of the present invention, there is provided an impact tool in which a load generated when a tool main body is pressed to a member to be fastened is not applied to a rotating portion or a bearing portion of a planetary gear mechanism.

1. An impact tool comprising:
a motor;
a housing that accommodates the motor;
a hammer rotated by the motor in a rotating direction;
an anvil struck by the hammer in the rotating direction;
an end tool holding portion connected to the anvil and protruding from a front part of the housing; and
a load receiving portion that receives a load of the hammer in a rear direction.

2. The impact tool according to claim 1,
wherein the hammer is connected to the motor through a first speed reducing mechanism portion connected to the motor and a second speed reducing mechanism portion connected to an output part of the first speed reducing mechanism portion, and
wherein the load receiving portion receives a load of the second speed reducing mechanism portion in the rear direction.

3. The impact tool according to claim 2,
wherein the first speed reducing mechanism portion and the second speed reducing mechanism portion each include a sun gear, a plurality of planetary gears and a ring gear,
wherein the hammer is connected to a planetary carrier of the second speed reducing mechanism portion, and
wherein the sun gear of the second speed reducing mechanism portion is connected to a planetary carrier of the first speed reducing mechanism portion.

4. The impact tool according to claim 3,
wherein the planetary carrier of the second speed reducing mechanism portion includes a hammer portion and an annular portion, and
wherein the annular portion can rotate relatively to the ring gear of the second speed reducing mechanism portion.

5. The impact tool according to claim 4,
wherein the load receiving portion includes the annular portion and the ring gear of the second speed reducing mechanism portion, and
wherein the load transmitted to the ring gear is transmitted to the housing.

6. The impact tool according to claim 5,
wherein the load receiving portion includes a thrust bearing.

7. An impact tool comprising:
a motor;
a housing that accommodates the motor;
an inner cover and a hammer case accommodated in the housing;
a hammer portion accommodated in a space defined by the inner cover and the hammer case and rotated by the motor in a rotating direction;
an anvil accommodated in the space defined by the inner cover and the hammer case and struck by the hammer in the rotating direction; and
an end tool holding portion protruding from a front part of the hammer case and connected to the anvil,
wherein a rear part of the hammer portion, in an axial direction of the hammer portion, is supported so as to freely rotate relative to the inner cover.

8. The impact tool according to claim 7,
wherein a load receiving unit is provided in a rear side of the hammer portion so as to receive an axial load and freely rotate relative to the inner cover.

9. The impact tool according to claim 8,
wherein the load receiving unit is a thrust bearing unit provided in the rear side of the hammer portion.

10. An impact tool comprising:
a motor;
a housing that accommodates the motor;
a hammer rotated by the motor in a rotating direction; and
an anvil struck by the hammer in the rotating direction,
wherein a thrust bearing is provided between a rear part of the hammer and the housing.

11. The impact tool according to claim 10,
wherein the hammer is rotated by the motor intermittently.

12. The impact tool according to claim 11,
wherein a planetary gear is supported by the hammer, and
wherein the thrust bearing is provided at an outside of the planetary gear in a diametrical direction of the planetary gear.

13. An impact tool comprising:
a motor,
a hammer rotated by the motor in a rotating direction, and
an anvil struck by the hammer in the rotating direction,
wherein the anvil is supported by the hammer so as to rotate freely.

14. The impact tool according to claim 13,
wherein the anvil is directly fitted to the hammer.
